(19) United States
(12) Patent Application Publication
(10) Pub. No.: US 2007/0002558 A1
(43) Pub. Date: Jan. 4, 2007

(54) Multi-positional track lighting device

(76) Inventor: Jae Won Kim Pryor, New York, NY (US)

Correspondence Address: CANTOR COLBURN, LLP, 55 GRIFFIN ROAD SOUTH, BLOOMFIELD, CT, 06002, US

(21) Appl. No.: 11/292,814

(22) Filed: Dec. 2, 2005

Related U.S. Application Data
(60) Provisional application No. 60/632,593, filed on Dec. 2, 2004.
(60) Provisional application No. 60/691,226, filed on Jun. 16, 2005.

(51) Int. Cl. F21S 8/00

(52) U.S. Cl. 362/147

(57) ABSTRACT

A lighting system that can be a track lighting system that allows lights to move in different directions such as in both a “x” direction and in a “y” direction. This lighting system can include a set of parallel tracks wherein at least one track is also slidable on this set of parallel spaced tracks. On that track is at least one light that can be electrically and mechanically coupled to that track. The device relies on a low voltage system which allows current to flow through the tracks.

### CROSS REFERENCE TO RELATED APPLICATIONS

This application is a non provisional application and hereby claims priority from U.S. Provisional Application Ser. No. 60/632,593 filed on Dec. 2, 2004 and Ser. No. 60/691,226 filed on Jun. 16, 2005 wherein the disclosures of which are hereby incorporated herein by reference.

### BACKGROUND OF THE INVENTION

The invention relates to a lighting system that can be a track lighting system that allows lights to move in different directions such as in both a “x” direction and in a “y” direction. Other lighting systems are known. For example, the following U.S. patents generally relate to this field U.S. Pat. No. 6,347,877 to Douglass II; U.S. Pat. No. 3,936,671 to Bobrick et al.; U.S. Pat. No. 5,993,030 to Barcel; U.S. Pat. No. 4,109,305 to Claussen et al.; U.S. Pat. No. 4,591,764 to Nilssen; U.S. Pat. No. 2,905,806 to Tunney; U.S. Pat. No. 5,440,469 to Gomes; U.S. Pat. No. 5,672,003 to Shemitz et al.; U.S. Pat. No. 6,540,372 to Joseph; U.S. Pat. No. 5,154,509 to Wulfman et al; U.S. Pat. No. 6,597,129 to Newman; U.S. Pat. No. 4,822,292 to Thayer et al; U.S. Pat. No. 5,785,411 to Komai et al.; U.S. Pat. No. 4,919,625 to Coutre; U.S. Pat. No. 5,013,251; U.S. Pat. No. 5,803,755; U.S. Pat. No. 4,688,154; U.S. Pat. No. 5,154,509 wherein the disclosures of which are hereby incorporated herein by reference.

### SUMMARY OF THE INVENTION

The invention can relate to a low voltage track lighting device which can comprise a first set of substantially parallel spaced tracks and a second set of tracks electrically and mechanically coupled to the first set of tracks such that the second set of tracks are movable along the first set of tracks. This type of movement can be a sliding movement, a rolling movement or any other type of movement known in the art.

There can be at least one light electrically and mechanically coupled to the second set of tracks such that the light is movable along the second set of tracks. With this design, there can be a current that can flow through the first set of tracks and into a second set of tracks and then from the second set of tracks into the light.

This design has many benefits. First, because a low voltage electrical current runs through the tracks themselves, there is no need for additional wiring or unnecessary wires, which could make this design more cumbersome and more costly. For example, if the lights had to be electrically connected via additional wiring to the second set of tracks, this would dramatically increase the complexity of the set up of a system. Instead, with the current system, a user only has to add a light using an existing light housing, which receives electrical power directly from the second set of tracks. Thus, a user does not have to electrically connect wires to the first set of tracks or to the second set of tracks to have a light in electrical communication with the system. A user only has to couple a light housing onto the second set of tracks for an additional light to work.

Since this system does not require unnecessary wires to connect between the first set of tracks and the second set of tracks and also between the second set of tracks and the light or the light housing, this allows for a freer mechanical movement of each of these parts with respect to each other.

For example, if the second set of tracks had to be hard wired to the first set of tracks, to create electrical communication between these tracks, the range of motion of the second set of tracks would be limited by the length or range of motion of the wire coupling the two tracks together. Instead, because of the direct electrical communication between these two tracks, the second set of tracks is free to move or slide to the fullest mechanical range of movement.

Similarly, because each light and/or light housing is in direct electrical communication with the second set of tracks, each light housing can be slid or moved from to its fullest mechanical extent without being limited by any wiring between the second set of tracks and the first set of tracks.

To create this direct connection between both the first set of tracks and the second set of tracks, the tracks can be designed to be of sufficient mechanical strength to support connecting elements while also be made from material that is suitable to conduct electricity. In at least one embodiment, the tracks can be substantially tubular shaped forming an elongated substantially cylindrically shaped element. These tubes can be in the form of telescoping tubes allowing for an adjustment in length. In another embodiment, the tracks can be formed similar to I-beams which are made entirely from electrically conductive material or being made from mechanically rigid material of lower conductivity with at least one section embedded therein which is made from a material of higher conductivity.

To facilitate this conduction of electricity, there can be at least one connection element that serves as both a mechanical connection and as an electrical connection between these two parts.

A first embodiment of a connection element can be in the form of a bracket that creates both a mechanical and electrical connection between either the first set of tracks and the second set of tracks or the second set of tracks and the light. This bracket can be in the form of a U-shaped coupling element, which can be used to slide over a track that can be shaped similar to a tube or elongated cylinder described above. This U-shaped bracket can either have a direct physical connection to the tube/track or it can also include rollers which are electrically conductive, which allow power to be transferred from a first section to another section. In one embodiment, these rollers can cover a substantial portion of the U-shaped bracket. In another embodiment these rollers can be comprised of at least three different rollers each spaced apart from each other.

Another type of coupling can be in the form of linear bearings. These linear bearings can both electrically and mechanically couple the first set of tracks to the second set of tracks and also electrically and mechanically couple the light to the second set of tracks. This linear bearing includes bearing elements which are electrically conductive, which in turn are both electrically and mechanically coupled to an outer housing which is both electrically and mechanically coupled to an additional element such as another set of tracks or a light housing.

Another type of coupling element can include rollers, which both electrically and mechanically couple the devices together. These rollers can roll on top of the tube type tracks described above and be used to transfer electrical power directly from a first set of tracks to the second set of tracks or to transfer power directly from the second set of tracks to a light or light housing.

Another way to form a direct connection between the light and the second set of tracks is to form the light housing as a connection element. In this case, the light housing can be in the form of a body and at least one but possibly at least two substantially curved, rounded, angled or even semi-circular, coupling elements, which form both an electrical and a mechanical connection between the second set of tracks and the light.

These coupling elements can be formed so that parts of them are isolated from particular tracks to create a selected flow of, current through the tracks. To create the proper circuit between the first set of tracks and the second set of tracks and between the second set of tracks and the light housing, particular connection elements may need to be selectively modified or designed so that a connection or coupling element has two mechanical connections each but only one electrical connection. In this case, a non conductive sleeve may be inserted into one of the connections to isolate the connection element from a connecting track to keep the circuit from shorting out.

With another design, tracks such as I-beam style tracks as described above can include at least two different sections, an electrically conductive section and non electrically conductive section, or alternatively a section which is of substantially lower conductivity than the electrically conductive section. With this design the non or lower electrically conductive section can be used to isolate a plurality of electrically conductive sections on a track.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1A is a perspective view of a first embodiment of the invention;

FIG. 1B is a top or plan view of a first embodiment of the invention;

FIG. 1C is a top view of an example of the electrical connection into the tracks shown in FIGS. 1A and 1B;

FIG. 2 is a top or plan view of a second embodiment of the invention;

FIG. 3A is a side view of an embodiment of a track;

FIG. 3B is a side view of another embodiment of a track;

FIG. 3C is a perspective view of another embodiment of the track;

FIG. 4A is a side view of another embodiment of the connection element;

FIG. 4B is a side view of the connection element shown in FIG. 4A which is rotated by 90 degrees;

FIG. 4C is a top view of the connection element;

FIG. 5A is a side view of a first connection element of a track;

FIG. 5B is another side view of the connection element shown in FIG. 5A;

FIG. 5C is a top view of the view shown in FIG. 5B;

FIG. 5D is a side view of another embodiment of the connection element;

FIG. 5E is a side view of the connection element shown in FIG. 5D;

FIG. 5F is a top view of the connection element shown in FIG. 5D;

FIG. 6A is a top view of another embodiment of a connection element;

FIG. 6B is a side view of the connection element shown in FIG. 6A;

FIG. 6C is a side cross sectional view along the longitudinal axis of the device shown in FIG. 6A;

FIG. 6D is a side view of the device shown in FIG. 6C;

FIG. 6E is a top view of the two elements having a connecting track extending between them;

FIG. 6F is a side cross sectional view of the roller bearing;

FIG. 6G is a front cross-sectional view of the roller bearing;

FIG. 7A is a side view of a first embodiment of a light fixture;

FIG. 7B is a bottom view of the light fixture shown in FIG. 7A;

FIG. 7C is a side view of another embodiment of the light fixture;

FIG. 7D is a bottom view of the light fixture shown in FIG. 4C;

FIG. 8A is a side view of another light fixture;

FIG. 8B is a bottom view of this light fixture;

FIG. 9A is a top view of a section of another embodiment of this invention;

FIG. 9B is a top view of a fuller section shown in FIG. 9A;

FIG. 10A is a perspective view of another embodiment of the invention;

FIG. 10B is a side view of a connection element shown in FIG. 10A;

FIG. 10C is a another side view of the connection element shown in FIG. 10A;

FIG. 11A is a top view of another connection element;

FIG. 11B is a side view of the device shown in FIG. 11A;

FIG. 11C is a side view of the device shown in FIG. 11B;

FIG. 11D is a bottom view of the device shown in FIG. 11A;

### DETAILED DESCRIPTION OF PREFERRED EMBODIMENTS

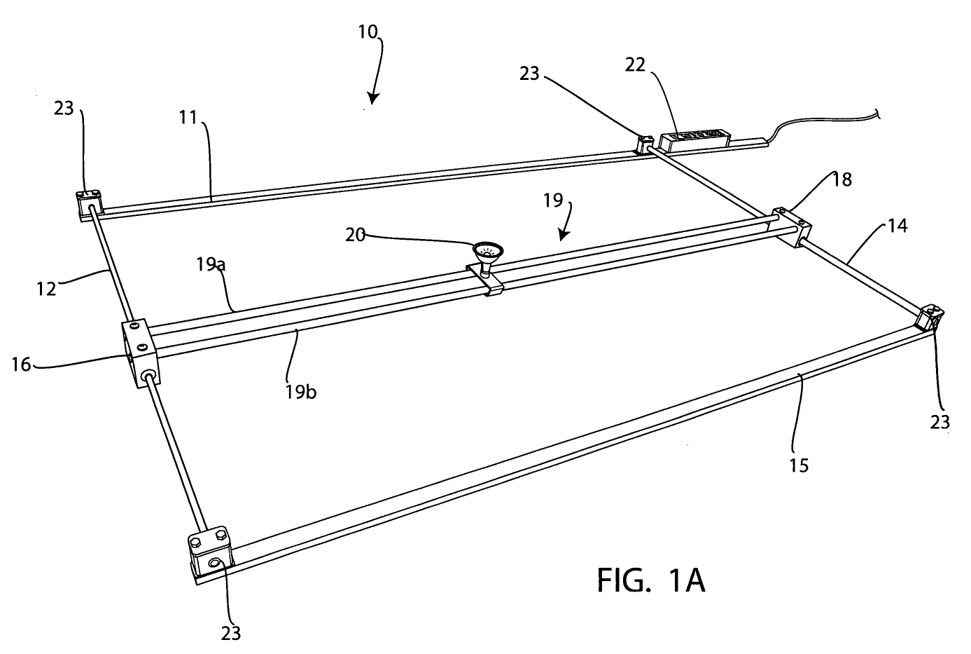

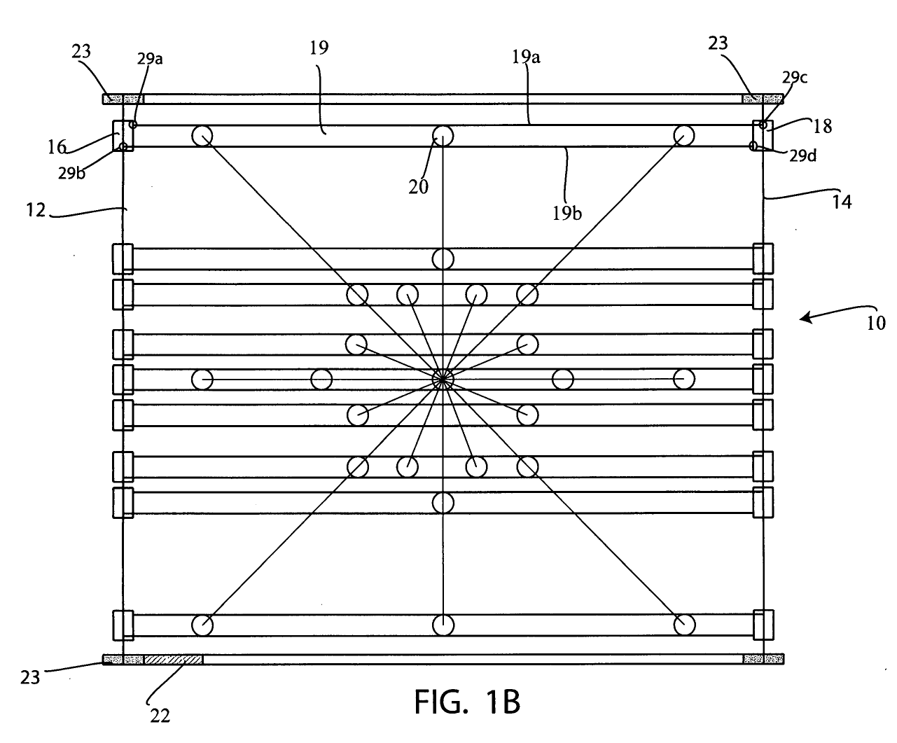

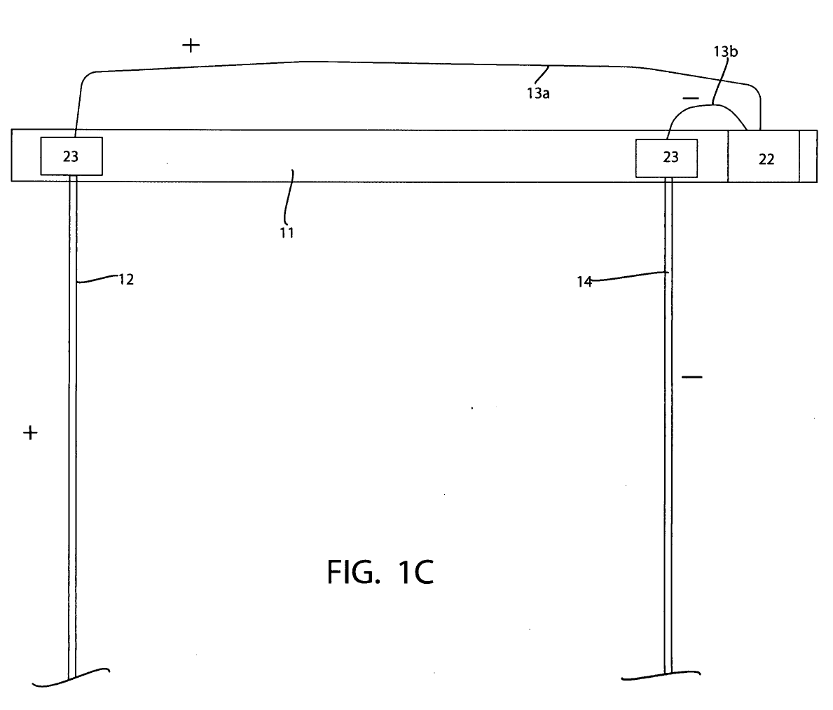

Referring to the drawings, FIG. 1A shows a perspective view of the device 10 positioned on a floor, and FIG. 1B shows a top view of a first embodiment of this invention. This device can be coupled to a floor, wall or ceiling of a building and for example may be coupled to the ceiling of a room at least one light pointing down to the floor.

The device 10 can include a plurality of tracks or rails 12 and 14 which can be charged with opposite polarity from a power source which may include a transformer 22. This power is bridged via a connection of a plurality of tracks 19 which can include at least two tracks 19a and 19b which allow at least one light 20 to be moved or slid on these tracks 19a and 19b. In addition, tracks 19a and 19b are coupled both mechanically and electrically to tracks 12 and 14 via connection elements 16 and 18. In this way, a track 19 can be slid on parallel extending tracks 12 and 14 to a particular position. In addition, light 20 can be slid or moved or slid on tracks 12 and 14 so that one particular light can be positioned in a particular position. Connection elements 16 and 18 are used to control current through tracks 19a and 19b so that tracks 19a and 19b carry a current of opposite polarity and therefore, light 20 provides a power connection between the two tracks thus allowing light 20 to illuminate. This power which is fed into the system can be at a relatively low voltage so that it does not harm a user who wishes to move a light or a track.

FIG. 1C shows a top view of the device which includes a cross beam 11 which can be in the form of a c-shaped beam which can be used to store or house wires such as wires 13a and 13b which may be connected to a set of vibration damping clamps 23. In this example, power cable 13a conducts a positive charge, while power cable 13b conducts a negative charge. Therefore, as an example, track 12 can conduct a positive charge while track 14 can conduct a negative charge.

Vibration damping clamps 23 can be used as a mechanical connection between a cross beam 11 and a first set of tracks 12. This vibration damping clamp 23 can also serve as an electrical connection between transformer 22 and the first set of tracks. Vibration damping clamp 23 then isolates current from the mounting beam so that while there is a mechanical connection between the cross beam or mounting beam 11, and the first set of tracks 12, or 14 there is no electrical connection between these tracks 12 or 14 and the mounting beam 11.

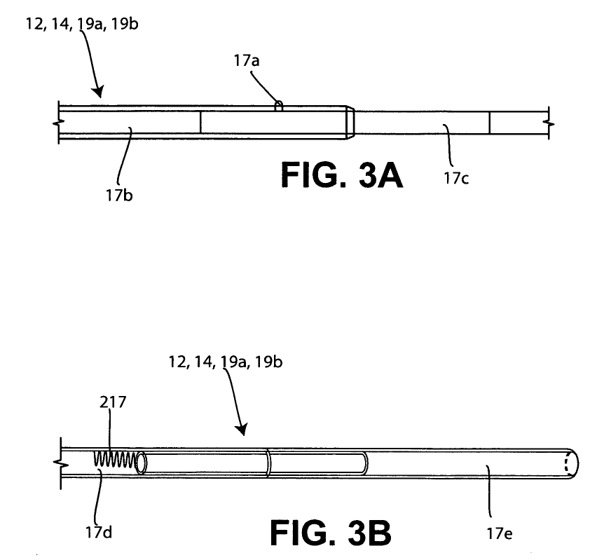

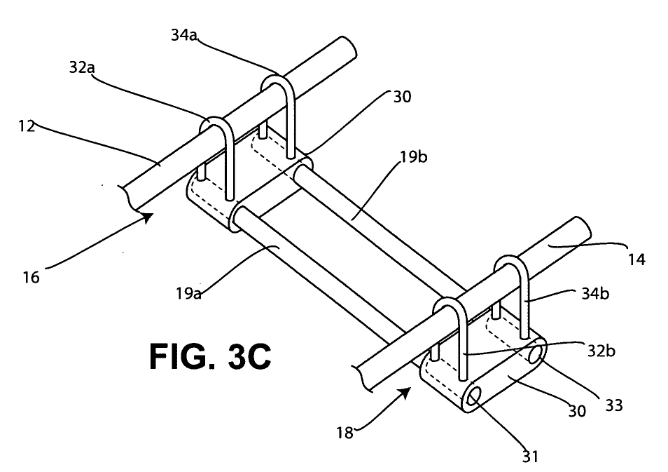

For example, as shown in FIG. 1B, track 19a is connected to connection element 16 at a first end at connection point 29a, and is connected to connection element 18 at connection point 29c. FIG. 1B shows that track 19a is mechanically coupled to connection element 16 but is electrically isolated from this track. This electrical isolation takes place inside of connection element 16 and is shown in greater detail in FIGS. 3B-6E. At the opposite end, track 19a is both electrically and mechanically coupled to connection element 18 because power is conducted directly from track 14 into the coupling element and this power then flows into the metal connection between the coupling element and track 19a.

Accordingly, track 19b which is also shown in FIG. 1B is connected in an opposite manner such that it is electrically and mechanically connected to track 12 at connection point 29b, while being electrically isolated but mechanically coupled to coupling element 18 on track 14 at connection point 29d.

Accordingly, because of this type of electrical connection, tracks 12, and 14 conduct electricity of opposite polarity while tracks 19a and 19b conduct electricity of opposite polarity.

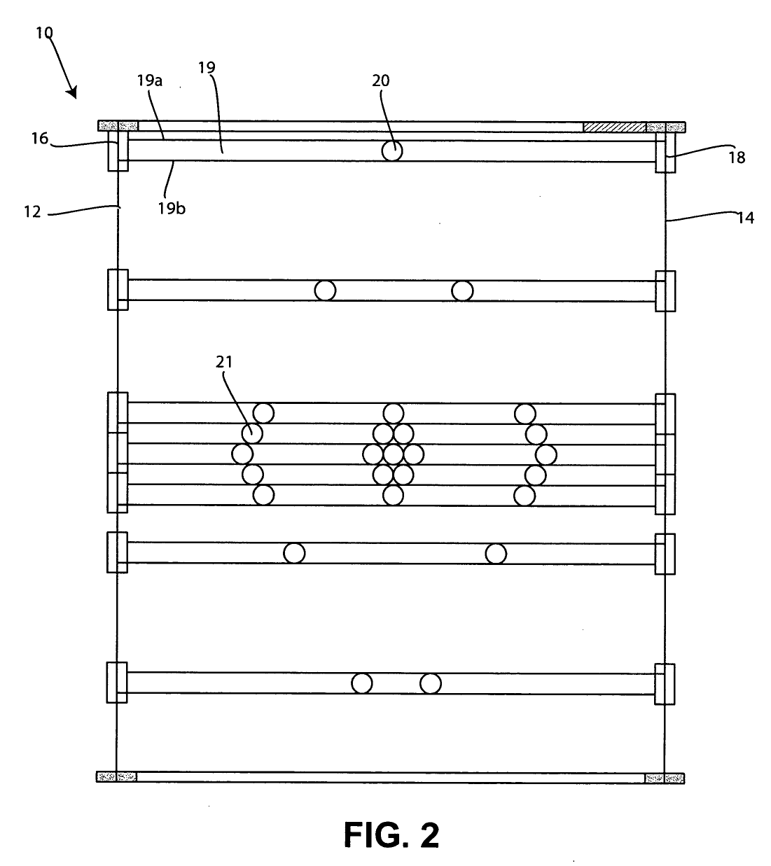

FIG. 2 is another view of another embodiment of the invention. In this view there is an additional type light 21, which can be coupled between two tracks 19 such that one end of the light is coupled to a line 19a on one track 19a while another end of the light is coupled to another line 19b on another track 19b.

Tracks 12, 14, 19a and 19b can be of any shape and can be made of any known sufficient material. The tracks can be made of a single length or be formed with adjustable lengths FIGS. 3A and 3B show examples of differing ways to extend a track line either with tracks 12 and 14 or tracks 19a and 19b. In this case, these tracks can be in the form of telescoping tracks that extend out to an adjustable length. For example, FIG. 3A discloses a telescoping track that can include a plurality of different segments 17b and 17c, which are coupled together in a telescoping manner. There is also a button or spring loaded detent 17a, which when pressed, allows these two tubes to move relative to each other so that they can be slid to the proper length.

FIG. 3B shows another embodiment wherein this embodiment discloses a first telescoping tube 17d and a second telescoping tube 17e wherein these two tubes can be slid relative to each other to create an adjustable support element or track 12, 14, 19a or 19b.

FIG. 3C shows a perspective view of another embodiment of the invention wherein in this view there are tracks 12 and 14 which have connection elements 16 and 18 coupled to these tracks. Connection elements 16 and 18 can include a connection block 30 and U-shaped connection rings 32 and 34 which can mechanically and electrically connect to tracks 12 and 14 to allow a track 19 including lines 19a and 19b to slide along this track. Block 30 also includes holes 31 and 33 for receiving lines 19a and 19b to allow a connection which can be both a mechanical and electrical connection.

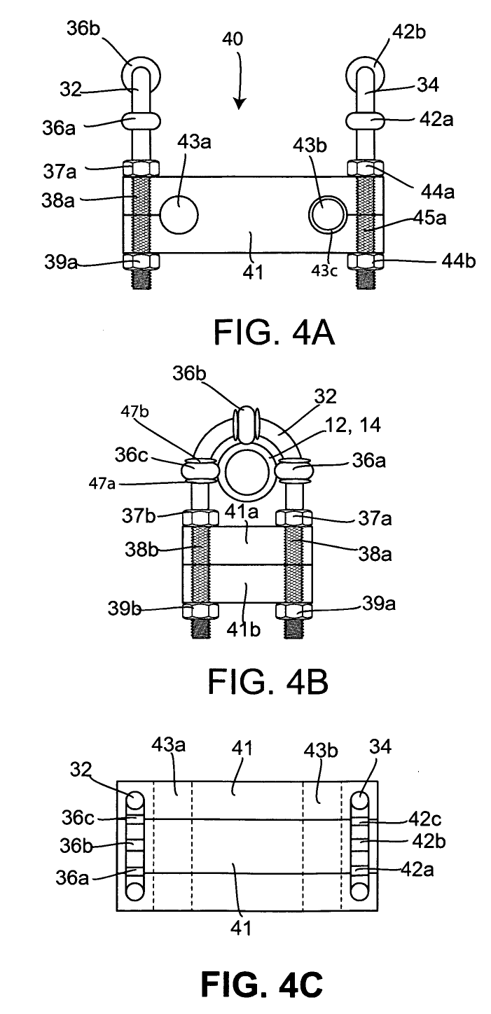

FIG. 4A is a side view of another embodiment of the connection element such as connection elements 16 and 18. In this view, a connection element 40 can include two U-shaped brackets 32 and 34, which are coupled to a body section 41. Bracket 32 can have at least three rollers 36a, 36b, and 36c, which are separated from each other on track 12 or 14 but providing spacing from the track. For example, roller 36b can provide a substantially vertical spacing while rollers 36a and 36c can provide a lateral spacing from tracks 12 and 14. Bracket 34 can also have three rollers 42a, 42b and 42c (See FIG. 4C), which function in a similar manner to the rollers 36a, 36b, and 36c described above. These rollers form an electrical and mechanical connection between tracks 12 or 14 and U-shaped brackets 32 and 34 so that current can flow from tracks 12 or 14 directly into U-shaped brackets 32 and 34 and then into housing 41.

U-shaped brackets 32 and 34 are mechanically coupled to housing 41 via a plurality of nuts fitting onto a bolt section of these brackets. For example, bracket 32 has a screw section, which can include two screw ends 38a and 38b (See FIG. 4B). Bracket 34 is also formed in a similar manner.

FIG. 4B is a side view of the connection element shown in FIG. 4A, which is rotated by 90 degrees. With this view, these two screw sections are slid into the two housing sections 41a and 41b, which are coupled one on top of the other and then secured on top and bottom by bolts 38a and 38b respectively, screwing into nuts 37a, 39a, 37b, 39b respectively. Similarly bolt 45a screws into nuts 44a and 44b.

Housing 41 can include at least two holes or openings 43a and 43b, which can be used to receive a second set of tracks, such as tracks 19a and 19b. These holes or openings 43a and 43b can extend through the entire housing perpendicular to the direction of the extension of tracks 12 or 14. At least one of these holes may include a tubular plastic insert 43 (See FIG. 4B) which can be used to electrically isolate a connecting track from the connection element.

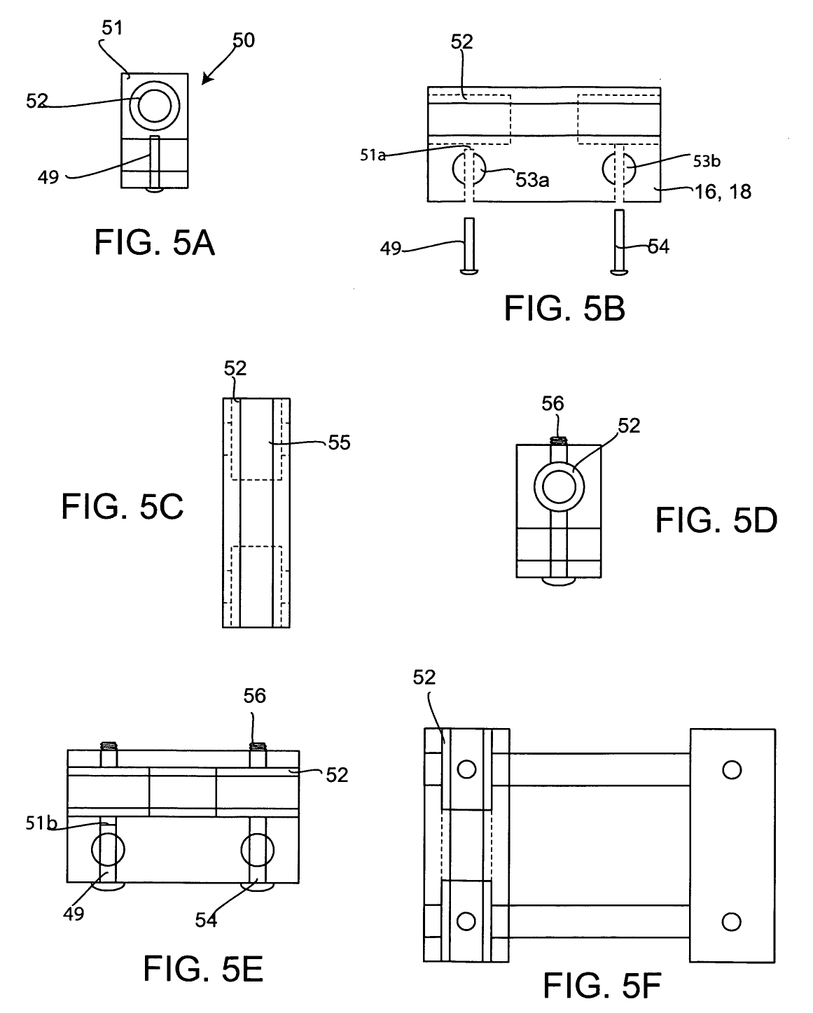

FIGS. 5A, 5B and 5C show another embodiment of the connection elements 16 and 18 shown in FIG. 1. With this design, there are connection elements 50 in the form of linear bearings, which can be used to allow a device to slide along a track, such as tracks 12 and 14, or this device can be used to allow the light fixture to slide along lines 19a and 19b as well. These linear roller bearings are disposed in section 52 of a body 51 and allow electricity to be conducted through the connection elements and into adjoining lines so that the device does not lose electrical contact. With this design there is at least one pin 54, which can be inserted into a hole 53 to fix the device in movement.

In this case, body 51 can be formed from a non-conductive material such as plastic while pins 49 and 54 are made from a metallic material and can be used to electrically link either track 12 or 14 to an associated track 19a or 19b. For example, pin 49 inserts into hole 53a and can be used to mechanically lock an associated track 19a or 19b to body 51. However, pin 49 does not extend up to section 52 which houses the linear bearing elements which are coupled to the associated track 12 and 14. Pin 49 is instead blocked by body section 51a.

However, pin 54 is longer than pin 49 and is used to mechanically secure either track 19a or track 19b to body 51 by extending through a hole in either one of these tracks. Pin 54 extends through body 51 to section 52 housing these linear bearings and either track 12 or 14. This extension of pin 54 creates a direct electrical connection between the tracks.

FIGS. 5D, and 5E, show another embodiment of the device which includes an additional pin 56 to allow the device to be securely fastened to a line or track. This additional pin 56 can be in the form of a screw which can be screwed into the body of this device, wherein when screw 56 is screwed in, it drives into an associated track such as tracks 12 and 14 to fix the connection elements in place. In this view, insert 51b is in the form of a plastic insert that electrically shields pin 49 from the associated track. This type of an insert 51b along with a shorter pin 49 can be used to electrically isolate one track from another so that the tracks do not cause an unnecessary shorting of the circuit.

FIG. 5F shows a top view of this device, which reveals one of these connection elements in a cross sectional view and the other of the connection elements in a top view.

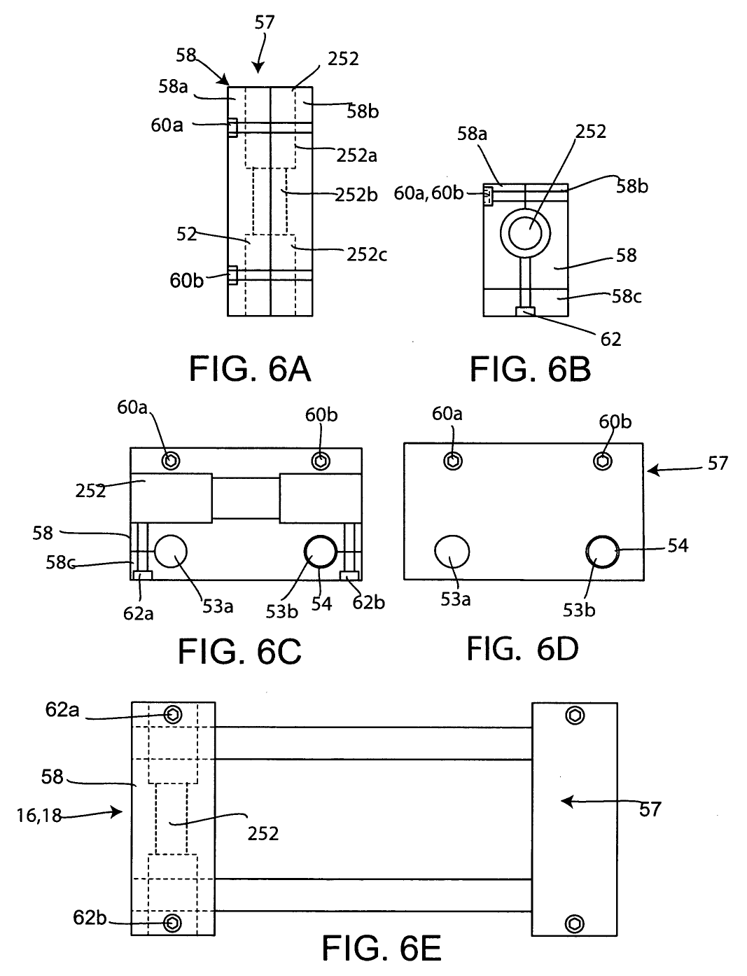

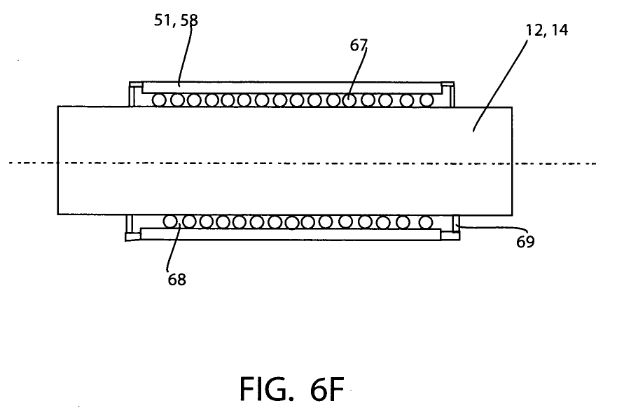

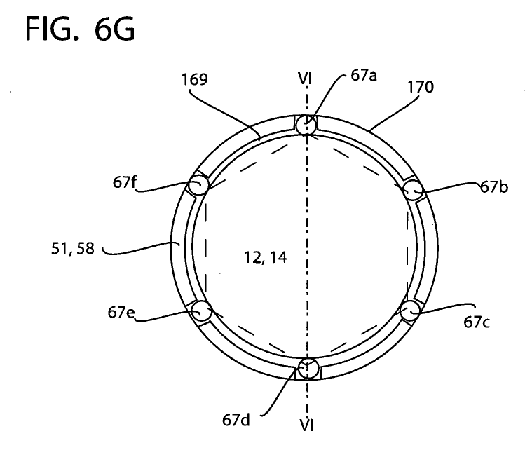

FIGS. 6A-6E show another type of connection element, which can be used to connect elements together. For example, this design can be used to connect the first set of tracks 12 and 14 to the second set of tracks 19 together.

For example, FIG. 6A discloses a coupling element embodiment 57, which can include a first split section 58a and a second split section 58b of a body 58. Body 58 can be made from any known material such as a conductive material which can be aluminum. These split sections (See also FIG. 6B) can be opened to receive any one of the first set of tracks and then screwed closed via screws 60a and 60b to clamp the split sections 58a and 58b closed. This clamping, if done sufficiently tight, can be used to fix this coupling element in place on the associated track 12 or 14 extending through it. In addition, as shown in FIG. 6B, there is also another set screw 62, which can be used to lock directly into a track 12 or 14 to form a selective direct locking connection with track 12 or 14.

This additional screw 62 can be used to secure a split section 58c to main body 58. As shown in FIG. 6C, which is a side cross-sectional view, there are holes or passageways 53a and 53b, which can be used to receive the additional or second set of tracks 19a and 19b. Inside hole 53b is a substantially non-conductive or insulating sleeve 54, which can be used to electrically isolate a connecting track so that there is no premature shorting of a circuit. FIG. 6D is a non-cross sectional view of the device shown in FIG. 6C. With this design, as shown in the example of connecting element 16, it is possible to electrically isolate a connecting track 19a from a first track 12 while allowing a second track 19b (See FIG. 1B) to be in both mechanical and electrical connection with this track. In addition, on the opposite side, with this type of coupling element it is possible to have track 19a in both electrical and mechanical connection with track 14 while track 19b is isolated electrically while in mechanical contact with this track.

FIG. 6E shows a top view of the design, which shows an implementation of the coupling element 57 in the form of generic coupling elements 16 and 18 and a dashed line which reveals passageway 252 and linear bearing housings 252a, and 252c. This view also shows setting screws 62a and 62b, which may be used along with setting screws 60a and 60b to fix this coupling element in place, or be used to fix second tracks 19 to this coupling element.

FIG. 6F shows a side cross sectional view of a roller or bearing element which includes a plurality of rolling balls 67 and an external housing 51, or 58 which can then move on a track 12 or 14. Rolling balls 67 are in the form of metal balls which form an electrical contact between housing 51, and 58 and track 12 or 14. Each of these balls are separated by a gap 68 which allows the balls to continuously roll inside of housing 51 and 58. These housings 51 and 58, have closed end brackets 69 which are used to keep these balls inside.

FIG. 6G shows a side cross sectional view of the device which is shown in FIG. 6F rotated by approximately 90 degrees. In this view there is shown rolling balls 67a, 67b, 67c, 67d, 67e and 67f which are each separated apart from each other in an equidistant manner. These balls are all housed and spaced apart from each other inside housing 51, and 58. These balls are used to space the housing 51, and 58 from the guides 12 and 14 by gap 169. An outer housing sheath 170 is used to surround these housings 51, and 58 and keep these balls 67 in place. With this design, current flows through guides 12 and or 14, through balls 67 and then into housing 51, 58 and also into outer sheath 170 so that current can then continue to flow into adjacent elements.

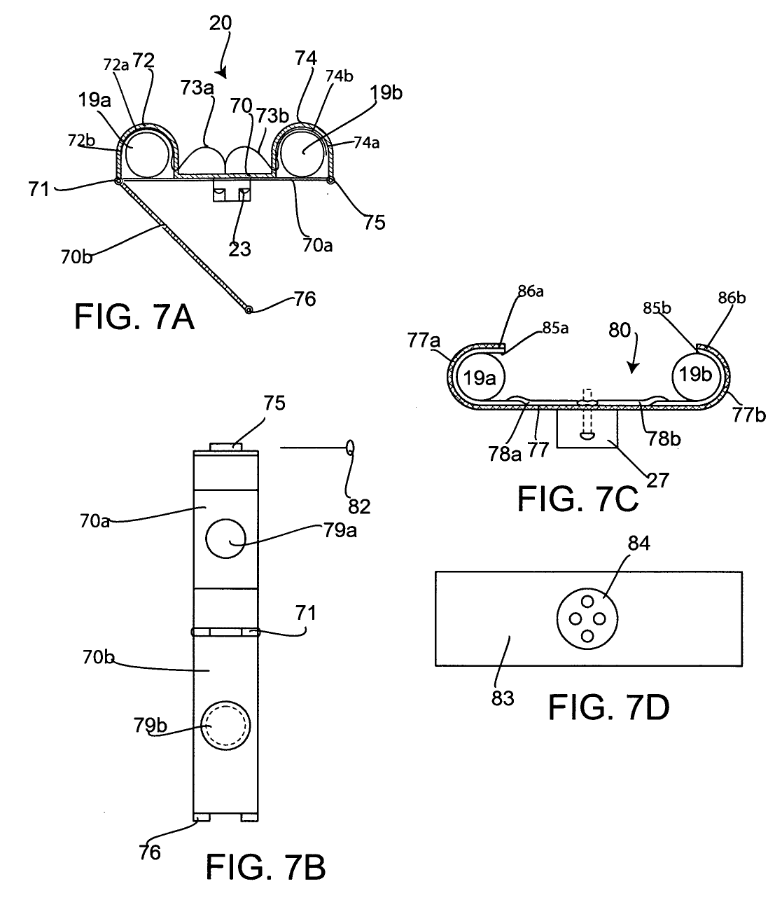

FIG. 7A shows a side view of one embodiment of a light fixture 20 which includes a body section 70 and two curved sections 72 and 74, which are set to fit over lines or sections 19a and 19b of a track 19. Body section 70 also includes face sections 70a and 70b, which form a face plate structure. This fixture allows the light to be in electrical and mechanical contact with track 19 while allowing light 20 to be moved on track 19. There is a light body 23, which connects to body section 70, wherein this light body 23 receives current through optional lines 73a and 73b coupled therein. Face section 70b is a hinged plate that is coupled to body section 70 via a hinge 71 and is thereby closed via a clasp 75 via a plate clasp section 76. FIG. 7B shows that the clasp can be closed via a pin 82. FIG. 7B shows a bottom view of this plate and shows the holes 79a and 79b, which can be used to receive the light fixture 23.

To complete the electrical connection between tracks 19a and 19b, and the light, each curved section 72 and 74 has respective plastic insert sections 72a and 74a which are coupled to a conductive material such as copper sections 72b and 74b which are respectively coupled to wires 73a and 73b.

FIG. 7C is a side view of another embodiment of this light fixture, which can include a clamp on device 80 wherein with this device, there is a light fixture 27 and curved portions 77a and 77b, which can snap over lines 19a and 19b and be electrically conductive with these lines via additional electrical lines 78a and 78b.

To complete the electrical connection between tracks 19a and 19b, and the light, each curved section 77a and 77b has respective plastic insert sections 86a and 86b coupled to the curved sections. These insert sections 86a and 86b are respectively coupled to a conductive material such as copper sections 85a and 85b which are respectively coupled to wires 78a and 78b.

FIG. 7D is a bottom section of this device, which shows a bottom plate 83 and a hole 84 for receiving lights such as a halogen light or LED lights.

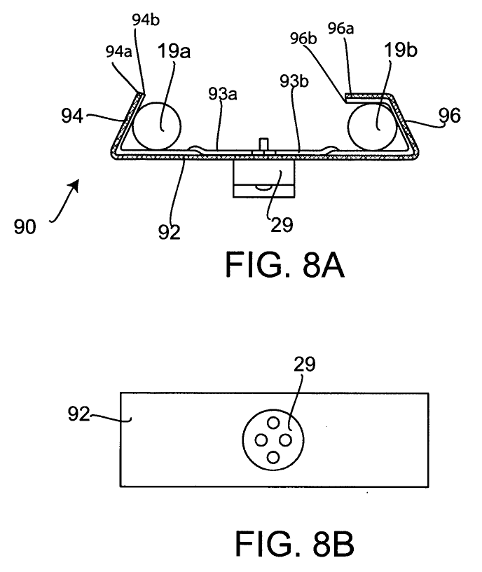

FIGS. 8A and 8B show a side view and a bottom view of another light connection device 90 which includes a base plate 92 and side connection elements 94 and 96. First connection element 94 can include only one bent portion so that it can snap over a line or track 19a. Second connection element 96 can include two bent portions 96a and 96b so that this device is securely fastened and can be rotated about track or line 19b. This device is in both electrical and mechanical contact with these lines 19a and 19b so that electrical current can pass to the light fixture 29.

To complete the electrical connection between tracks 19a and 19b, and the light, each angled section 94 and 96 has respective plastic insert sections 94a and 96a which are coupled to a conductive material such as copper sections 94b and 96b which are respectively coupled to wires 93a and 93b.

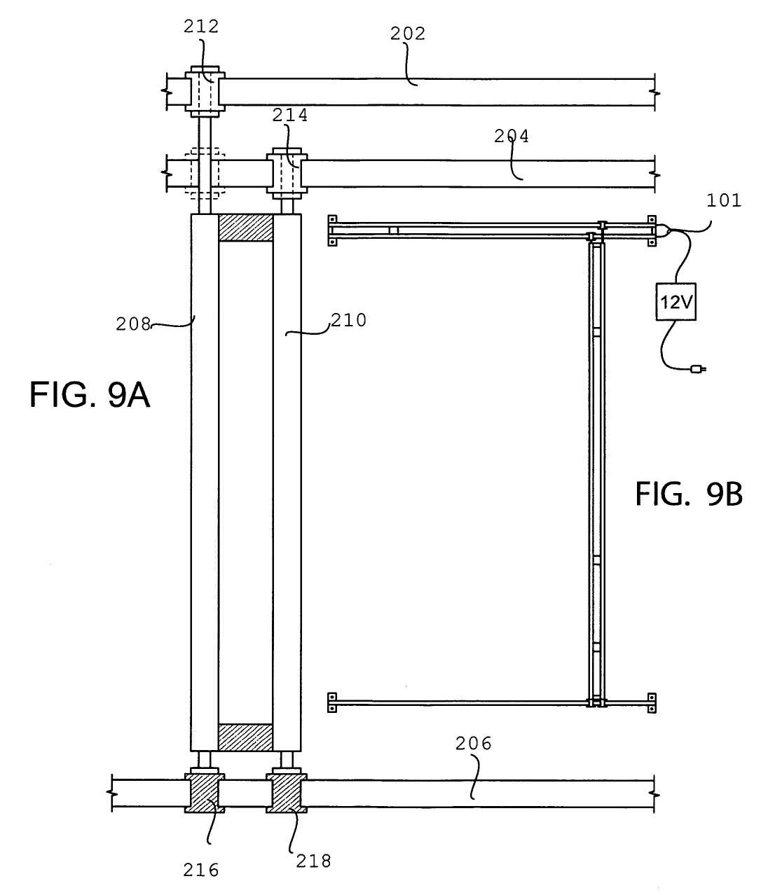

FIGS. 9A and 9B show a top view of another embodiment of the invention wherein the device can include at least two tracks on at least one side. In this design, there is a set of tracks 202 and 204, wherein track 202 has a positive current running through it, while track 204 has a negative current running through it. FIG. 9A is a close up view of a section of the track while FIG. 9B is a top view of the entire track extending across a region such as a room. Attached at one end of the track is a transformer 101, which can be used to control the current running through tracks 202 and 204. There is also an additionally spaced track 206, which acts as a mechanically stabilizing track for cross tracks 208 and 210. Tracks 202, 204 and 206 are spaced apart from each other in a substantially parallel manner while tracks 208 and 210 are spaced apart from each other in a substantially parallel manner but also intersect each of these tracks in a perpendicular manner. There are also connection elements 212, 214, 216 and 218, which can be used to connect these tracks together. These connection elements can be rotatably coupled to tracks 208 and 210 and also be used to roll across the top of these tracks 202, 204 and 206.

Tracks 202 and 204 conduct a low voltage current through them such that, in this example, track 202 conducts a positive current throughout a substantial portion of the track while track 204 conducts a negative current throughout a substantial portion of the track. Because track 208 is both electrically and mechanically coupled to track 202, it also conducts a positive current through it. In addition, track 210 is coupled both mechanically and electrically to track 204 so that it conducts a negative current through it. A lighting fixture can then be coupled to tracks 208 and 210 so that it forms a circuit between the two tracks running this current. If any of tracks 208 or 210 jams on running tracks 202, 204 or 206, these tracks 208 or 210 could be selectively adjustable in length such as shown in FIGS. 3A and 3B. In addition the length adjustability of these tracks could be controlled by having these telescoping tracks being spring loaded adjustable in length via spring 217 as shown in FIG. 3B.

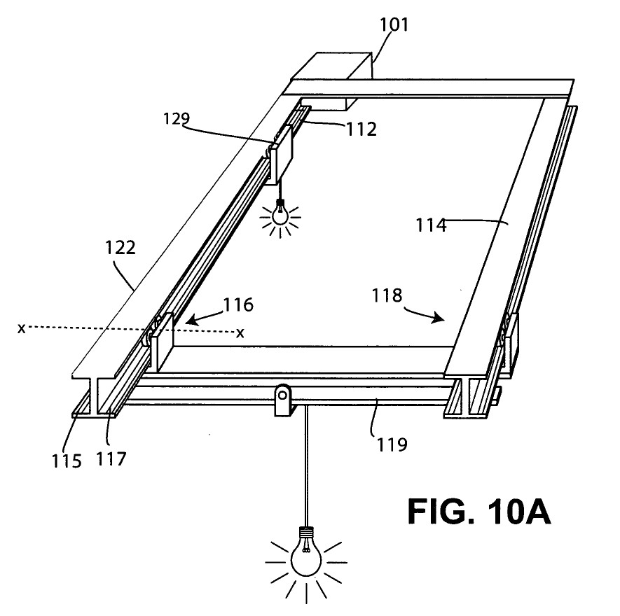

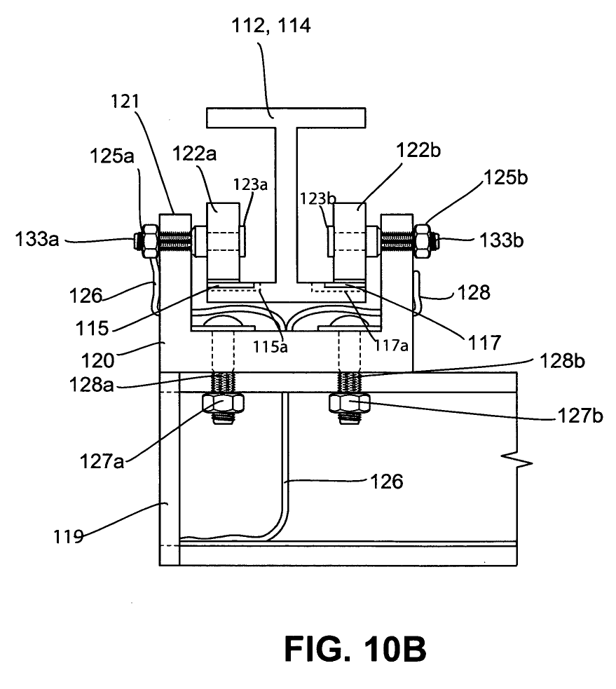

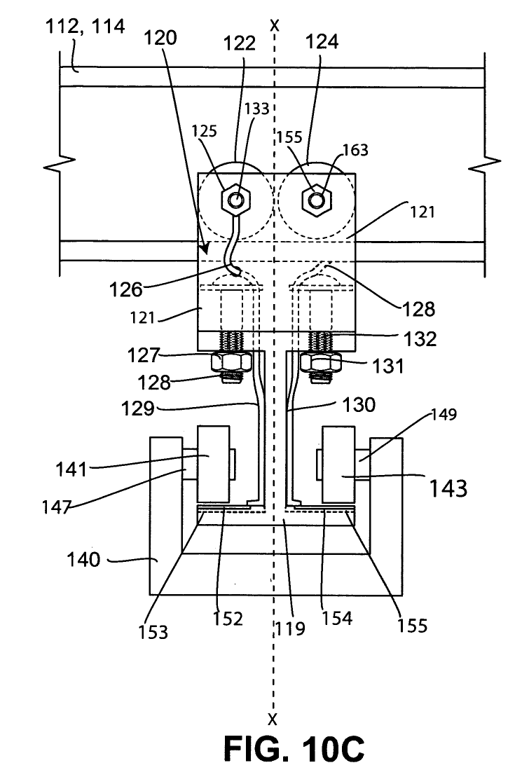

FIG. 10A is a perspective view of another embodiment of the invention. In this view there is shown a section of a rolling track, which includes a first set of beams 112 and 114 and a second set of beams 119 which can be in the form of I-beams and can extend between beams 112 and 114 in a perpendicular manner. Cross beam 119 is coupled to beams 112 and 114 via connecting elements 116 and 118. These connecting elements 116 and 118 can be in the form of rolling guides There is also another connecting element 129 which can be positioned on beam 112 as well.

FIG. 10B is a another side view of the connection element shown in FIGS. 10A and 10C. In this view track 112 or track 114 is shown, wherein this view is a side cross sectional view taken along the line X-X.

In this view there is shown both sides of track 112 or 114, which shows that coupling element 120 including body 121 extends in a U-shape around track 112 or track 114. In this view there is shown wheels 122a and 122b which are coupled to axles 123a and 123b in a mechanical manner. Axles 123a and 123b are both electrically and mechanically coupled to bolts 133a and 133b. These bolts 133a and 133b are secured via nuts 125a and 125b to body 121. Wires 126a and 128 extend down from bolts 133a and 133b to track 119.

Track 119 is coupled to bracket body 121 via bolts 128a and 128b which are secured by nuts 127a and 127b.

These tracks or beams 112, 114, and 119 can all include strips or lines which can be electrically conducting lines wherein these strips or lines 115 and 117 can be used to conduct a low voltage current throughout the device. Coupled to strips or lines 115 and 117 are non-conductive strips 115a and 117a which can be in the form of plastic strips which can be used to electrically isolate strips or lines 115 and 117 from each other.

FIG. 10C is a side cross sectional view of a connection element shown in FIG. 10A taken along the line X-X. In this view there is shown a track 112 which can be in the form of an I-beam. There is also connection element 120 which has wheels 122 and 124 (See FIG. 10C) rotatably coupled to the housing of this connection element 120. Wheels 122 and 124 are secured via axles 133 and 163 which are also coupled to frame 121 via nuts 125 and 155 respectively.

To electrically connect the first set of tracks 112 and 114 to the second set of tracks 119, wheels 122 and 124 can be electrically coupled to respective wires 126 and 128 by clamping wires to housing 121 and bolts 133 and 163 which allows current to flow from tracks 112 and 114 to wires 126 and 128 and then down into separate tracks 152 and 154 on track 119.

Track 119 which can form a second set of tracks similar to track 19, is bolted to housing 121 via bolts 128 and 132 and nuts 127 and 131. Track 119 has two current running track sections 152 and 154 which are in electrical and mechanical contact with wheels 141 and 143. Wheels 141 and 143 ride on track sections 152 and 154 respectively. Tracks 152 and 154 can be inlaid on track or beam 119 on base tracks that are coupled to track 119. Base track sections 153 and 155 can be formed from a plastic material which electrically isolates each track section 152 and 154 from the other. These base track sections 153 and 154 are used to electrically isolate the tracks 152 and 154 from each other. Wheels 141 and 143 are coupled to axles 147 and 149. These axles are coupled to a bracket 140 which can then be coupled to an associated light. Current can then flow from tracks 112 and 114, through wheels 122 and 124, through associated wires 129, 130 and into respective tracks 152 and 154. This current then flows through wheels 141, and 143, through respective axles 147 and 149, and into bracket 140 such that this current would then flow into a light such as shown by way of example in FIGS. 4A-4D and 6A and 6B.

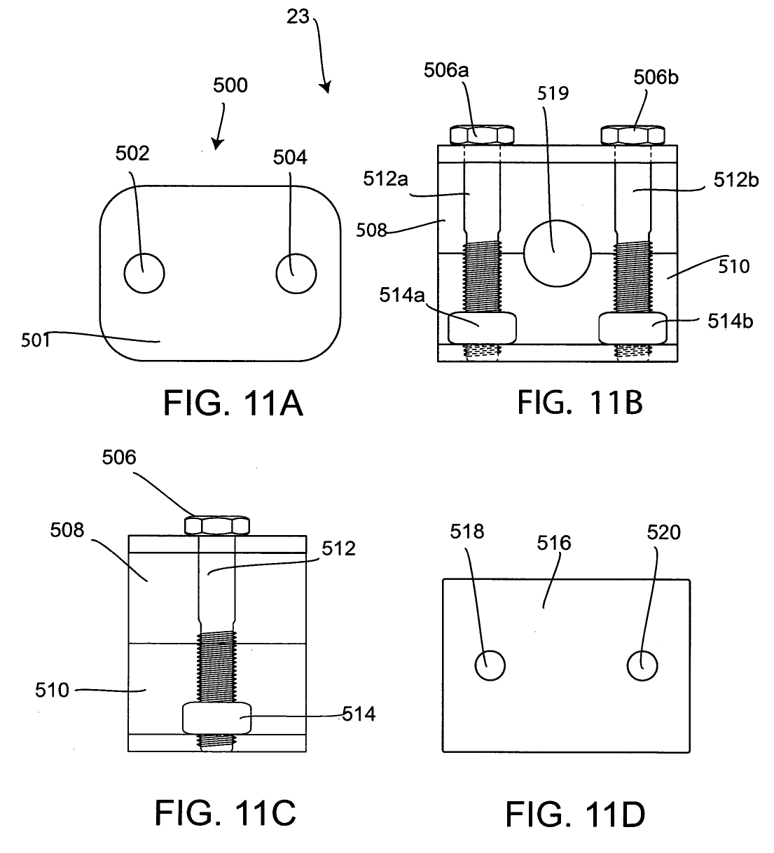

FIG. 11A is a top view of another connection element 500 which can serve as an example of a vibration damping clamp 23 shown in FIG. 1.

In this view, there is a top flange body 501 and clamping holes 502 and 504. These clamping holes 502 and 504 can be used to receive bolts 506a and 506b, which are secured via associated threaded receiving sections 514a and 514b which allow bolts 506a and 506b to be secured, to couple body sections 508 and 510 together. These body sections 508 and 510 can be clamped together to form a hole section 519 which can be used to receive an associated track such as tracks 12 or 14. These body sections 508 and 510 can be formed from a vibration damping material, such as a substantially stiff rubber material. Another side view of this device is shown in FIG. 11C as well as a bottom view shown in FIG. 1D. This vibration damping element 23 can be used as an electrical connector as shown in FIGS. 1A-1C wherein hole 519 can be used to receive either track 12 or 14 and also be used to receive an electrical connection from wires 13a and 13b (See FIG. 1C).

With all of the embodiments described above, there are a first set of tracks that include at least two tracks spaced apart from each other and a second set of tracks extending between these tracks. This second set of tracks are electrically and mechanically coupled to the first set of tracks such that there is no need for unnecessary wiring. In addition, the coupling of the light to the second set of tracks can be performed using a light housing that is both electrically and mechanically coupled to the second set of tracks to eliminate any unnecessary wiring as well. These designs therefore result in a system that is easy to install, upgrade and manipulate.

Accordingly, while a few embodiments of the present invention have been shown and described, it is to be understood that many changes and modifications may be made thereunto without departing from the spirit and scope of the invention as defined in the appended claims.

What is claimed is:

1. A low voltage track lighting system comprising:
a) a first set of tracks;
b) a second set of tracks movably coupled to said first set of tracks;
c) a plurality of connection elements in the form of linear bearings coupling said second set of tracks to said first set of tracks; and
d) a light movably coupled to said second set of tracks wherein said light is movable in at least two different directions in a plane via said light moving with respect to said second set of tracks and said second set of tracks being movable with respect to said first set of tracks and wherein said first set of tracks, said second set of tracks and said plurality of connection elements conduct electricity to provide electrical power to said light.

2. The device as in claim 1, wherein said first set of tracks comprises at least two substantially parallel spaced tracks which are spaced apart from each other.

3. The device as in claim 1, wherein said second set of tracks comprises at least two substantially parallel spaced tracks which extend from at least a first track of said first set of tracks to at least a second track of said first set of tracks.

4. The device as in claim 1, wherein said first set of tracks comprise a first track and a second track, wherein said first track conducts a positive current and said second track conducts a negative current.

5. The device as in claim 4, further comprising a transformer electrically coupled to said first set of tracks wherein said transformer controls the voltage and current running through the tracks.

6. The device as in claim 1, further comprising at least one vibration damping element coupled to at least one track of said first set of tracks.

7. The device as in claim 1, wherein said light comprises a housing having a plurality of U-shaped connection elements, which can be slidably coupled to said second set of tracks.

8. The device as in claim 7, wherein said light housing has a face, a hinge and a clasp closing so that said light housing can be selectively opened to insert or remove a selected light element from said light housing.

9. The device as in claim 1, wherein at least one of said plurality of connection elements comprise a fixing element which can be used to fix at least one of said plurality of connection elements in a particular location.

10. A low voltage track lighting system comprising:
a) a first set of tracks;
b) a second set of tracks movably coupled to said first set of tracks;
c) a plurality of connection elements in the form of rollers coupling said second set of tracks to said first set of tracks; and
d) a light movably coupled to said second set of tracks wherein said light is movable in at least two different directions in a plane via said light moving with respect to said second set of tracks and said second set of tracks being movable with respect to said first set of tracks.

11. A low voltage track lighting system comprising:
a) a first set of tracks comprising at least three tracks all spaced apart from each other in a substantially parallel manner, said first set of tracks comprising at least a first track having a positive current flowing through it, at least a second track having a negative current flowing through it and at least a third track serving as a ground track;
b) a second set of tracks spaced apart from each other in a substantially parallel manner and comprising at least a first track and a second track said second set of tracks being movably coupled to said first set of tracks;
c) a plurality of coupling elements in the form of rollers coupling said second set of tracks to said first set of tracks; and
d) a light movably coupled to said second set of tracks wherein said light is movable in at least two different directions in a plane via said light moving with respect to said second set of tracks and said second set of tracks being movable with respect to said first set of tracks in substantially the same plane.

12. The device as in claim 11 further comprising a transformer coupled to said first set of tracks.

13. The device as in claim 11, further comprising a vibration damping element coupled to said first set of tracks such that when said light moves said vibration damping element dampens any friction created from the light moving.

14. A low voltage track lighting device comprising:
a) a first set of tracks comprising at least two substantially parallel spaced tracks including a first track and a second track;
b) at least one second set of tracks coupled to said first set of tracks such that said second set of tracks have a first end and a second end, with said first end of said second set of tracks coupled to said first track of said first set of tracks and said second end of said second set of tracks coupled to said second track of said first set of tracks, wherein said second set of tracks are movable along said first set of tracks; and
c) at least one light electrically and mechanically coupled to said second set of tracks such that said light is movable along said second set of tracks, wherein a current flows through at least one track of said first set of tracks and into at least one track of said second set of tracks and wherein said at least one light receives electrical power directly from said at least one track of said second set of tracks.

15. The device as in claim 14, wherein each of said first set of tracks conduct electricity and wherein said second set of tracks are both electrically and mechanically coupled to said first set of tracks.

16. The device as in claim 14, wherein said first set of tracks comprises at least two tracks and said second set of tracks comprises at least two tracks and wherein a first track of said first set of tracks is electrically coupled to a first track of said second set of tracks and a second track of said first set of tracks is electrically coupled to a second track of said second set of tracks.

17. The device as in claim 16, wherein said first track of said first set of tracks is electrically isolated from said second track of said second set of tracks and said second track of said first set of tracks is electrically isolated from said first track of said second set of tracks.
